(19) United States
(12) Patent Application Publication
(10) Pub. No.: US 2014/0236383 A1
(43) Pub. Date: Aug. 21, 2014

(54) IN-VEHICLE APPARATUS

(71) Applicant: DENSO CORPORATION, Kariya-city (JP)

(72) Inventors: Yasutsugu NAGATOMI, Chiryu-city (JP); Tadashi KAMADA, Nagoya-city (JP); Yuichiro ISHII, Toyota-city (JP)

(73) Assignee: DENSO CORPORATION, Kariya-city (JP)

(21) Appl. No.: 14/169,344

(22) Filed: Jan. 31, 2014

(30) Foreign Application Priority Data
Feb. 20, 2013 (JP) 2013-31081
Oct. 30, 2013 (JP) 2013-225190

(51) Int. Cl. B60R 99/00

(52) U.S. Cl. CPC B60R 99/00
USPC 701/1

(57) ABSTRACT

An in-vehicle apparatus in a vehicle executes a vehicular application software-program and communicates with an information center that manages a general attribute of the application software-program. The in-vehicle apparatus includes an information acquisition section and an information transmission section. The information acquisition section acquires a general-attribute information data while the application software-program is executed, the general-attribute information data being an information data on the general attribute of the application software-program. The information transmission section transmits the general-attribute information data acquired by the information acquisition section to the information center (i) when a period of time for which the application software-program is executed reaches a predetermined threshold period of time or (ii) when an execution count that is a count of executions of the application software-program reaches a predetermined threshold execution count.

### CROSS REFERENCE TO RELATED APPLICATION

The present application is based on Japanese Patent Applications No. 2013-31081 filed on Feb. 20, 2013 and No. 2013-225190 filed on Oct. 30, 2013, the disclosure of which is incorporated herein by reference.

### TECHNICAL FIELD

The present disclosure relates to an in-vehicle apparatus in a vehicle to execute a vehicular application software-program used by a user who is in the vehicle.

### BACKGROUND ART

Patent Literature 1: JP 2004-251756 A

Patent Literature 1 describes a technology of an operation menu having hierarchical operation steps displayed in a vehicular display apparatus. The technology previously designates the number of allowed operation steps, which are allowed for a user in a vehicle, based on a driving workload of the user. That is, the number of allowed operation steps is previously designated to be increased or decreased as the driving workload is decreased or increased, respectively. Furthermore, a user's operating period of time needed for operating the operation menu is monitored; based on the monitored operating period of time, the above number of allowed operation steps is changed, if necessary. In contrast, an operation menu is provided with (i) a first menu information data having a large number of operation steps and (ii) a second menu information data having a small number of operation steps. Whether to use the first menu information data or the second menu information data for displaying the operation menu is determined based on the number of allowed operation steps that is determined according to the detected driving workload and the monitored operating period of time of the user.

### SUMMARY

Patent Literature 1 may describe a vehicular display apparatus that acquires a user's individual operating capability by monitoring the operating period of time to thereby reflect the acquired capability on designation of the number of avowed operation steps for the operation menu. Patent Literature 1 may unfortunately fail to describe the feedback of such user's individual operating capability, which is acquired when the user operates the vehicular display apparatus, to general information (e.g., general attributes) on the vehicular display apparatus.

Further, similarly, Patent Literature 1 may fail to describe the feedback of actual usages of each vehicular application software-program to general attributes on each vehicular application software-program.

It is an object of the present disclosure to provide an in-vehicle apparatus that acquires information data when executing a vehicular application software-program (also referred to an application, or application software) to thereby feed back the acquired information data to general attributes on the vehicular application software-program.

To achieve the above object, according to an example of the present disclosure, an in-vehicle apparatus in a vehicle is provided as follows. The in-vehicle apparatus executes a vehicular application software-program and communicates with an information center that manages a general attribute of the application software-program. The in-vehicle apparatus includes an information acquisition section and an information transmission section. The information acquisition section acquires a general-attribute information data while the application software-program is executed; the general-attribute information data is an information data on the general attribute of the application software-program. The information transmission section transmits the general-attribute information data acquired by the information acquisition section to the information center (i) when a period of time for which the application software-program is executed reaches a predetermined threshold period of time or (ii) when an execution count that is a count of executions of the application software-program reaches a predetermined threshold execution count.

Under such a configuration, the in-vehicle apparatus executes a vehicular application software-program while a user is in the vehicle or the user is driving the vehicle, thereby acquiring some general-attribute information data (information data on general attribute) of the application software-program under being executed. The total period of time (e.g., accumulated period of time, accumulated activation period of time, or accumulated execution period of time) for which the application software-program is executed eventually reaches a predetermined threshold period of time, thereby satisfying a transmission condition; alternatively, the execution count that is a count of accumulated or repeated executions of the application software-program eventually reaches a predetermined threshold execution count, thereby satisfying a transmission condition. Under such a transmission condition being satisfied, the accumulated general-attribute information data are permitted to be transmitted to the information center. That is, when the general-attribute information data of a subject vehicular application software-program is accumulated in a vehicle up to a significant amount, the accumulated amount of the general-attribute information data is transmitted to the information center. The subject application software-program may be any one of a plurality of vehicular application software-programs that are able to be used or executed by a plurality of users in a plurality of vehicles.

Then, the information center can acquire the general-attribute information data of the subject application software-program based on practical usages of the subject application software-program. As a result, the information center can feed back the general-attribute information data, which are received from a plurality of in-vehicle apparatuses, to the general attributes of the subject application software-program, thereby updating the general attributes of the subject application software-program.

### BRIEF DESCRIPTION OF THE DRAWINGS

The above and other objects, features, and advantages of the present disclosure will become more apparent from the following detailed description made with reference to the accompanying drawings. In the drawings:

FIG. 1 is a block diagram illustrating a configuration of an in-vehicle apparatus and an information center according to an embodiment of the present disclosure;

FIG. 2 is a diagram illustrating correspondence between an application and a regulatory level;

FIG. 3 is a diagram illustrating correspondence between a regulatory level, an upper limit of workload range permitting execution of an application software-program, and a level change condition;

FIG. 4 is a flowchart diagram illustrating a process of calculating an occurrence frequency of a sudden acceleration and sudden deceleration;

FIG. 5 is a flowchart diagram illustrating a process of calculating an occurrence frequency of a sudden deceleration;

FIG. 6 is a diagram illustrating a region determining a sudden deceleration;

FIG. 7 is a flowchart diagram illustrating a process of calculating an occurrence frequency of a sudden deceleration;

FIG. 8 is a diagram illustrating a region determining a sudden deceleration;

FIG. 9 is a flowchart diagram illustrating a process of calculating an occurrence frequency of a sudden acceleration;

FIG. 10 is a diagram illustrating a region determining a sudden acceleration;

FIG. 11 is a flowchart diagram illustrating a process of calculating an occurrence frequency of a sudden change of traveling direction;

FIG. 12 is a diagram illustrating a region determining a sudden change of traveling direction;

FIG. 13 is a flowchart diagram illustrating a process of calculating an occurrence frequency of a gaze directed to display indicating execution of an application;

FIG. 14 is a diagram illustrating a region determining a gaze directed at display indicating execution of an application;

FIG. 15 is a flowchart diagram illustrating a process of preparing a correspondence table between a user information data and an application;

FIG. 16 is a diagram illustrating correspondence between an application and age/gender of user;

FIG. 17 is a diagram illustrating correspondence between an application and a level of driving skill;

FIG. 18 is a flowchart diagram illustrating a process of managing an application;

FIG. 19 is a flowchart illustrating a process of determining whether to satisfy a change condition for a regulatory level; and

FIG. 20 is a flowchart diagram illustrating a process of updating a regulatory level.

### DETAILED DESCRIPTION

The following explains embodiments of the present disclosure to achieve an in-vehicle apparatus that executes a vehicular application software-program, with reference to drawings. In the embodiments mentioned below, mutually identical or equivalent members are assigned with an identical reference number; the explanation of a member having an identical reference number applies to another member having the identical reference number.

### First Embodiment

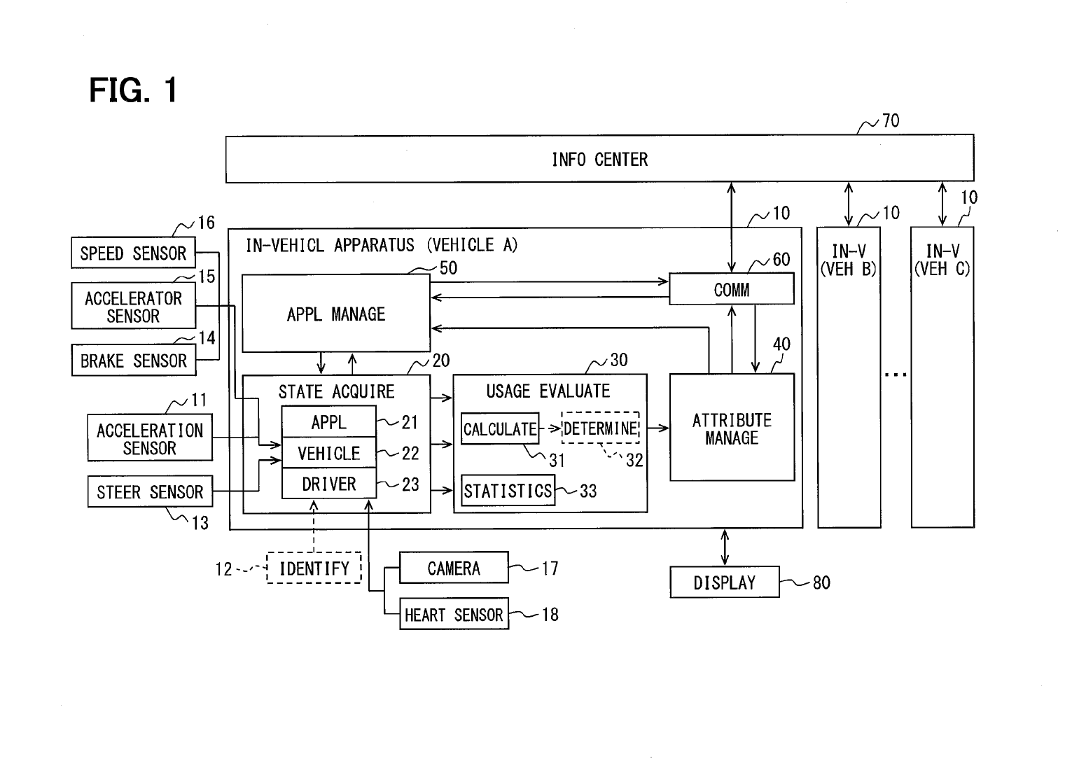

FIG. 1 illustrates an information center 70 and a plurality of in-vehicle apparatuses 10 according to a first embodiment of the present disclosure. The in-vehicle apparatus 10 includes a microcomputer and a center communication section 60 permitting communication with the information center 70. The microcomputer has a CPU, ROM, RAM, I/O, and a bus line connecting the foregoing components or the like. In the present embodiment, as an example, the microcomputer achieves functions of a state acquisition section 20, a usage evaluation section 30, an attribute management section 40, and an application management section 50 as software sections by using the CPU executing programs stored in the ROM. Furthermore, the above sections 20, 30, 40, 50 each may be achieved not only (i) as a software section in combination with a hardware unit (e.g., microcomputer), but also (ii) as a hardware section (e.g., integrated circuit, hard-wired logic circuit), including or not including a function of a related apparatus. Further, the hardware section may be inside of a microcomputer.

The state acquisition section 20 and the usage evaluation section 30 may function as an information acquisition section that acquires information data (also referred to as general-attribute information data) about general attribute of at least one vehicular application software-program (hereinafter, also referred to as “an application,” or “application software”) which is executed in each of a plurality of in-vehicle apparatuses 10. The general attribute includes (i) a regulatory level that indicates a range (or workload range) of vehicle driving workload that permits execution of an application, and (ii) a user layer of a user (i.e., a driver) using the application. The state acquisition section 20 and the usage evaluation section 30 acquire, as an information data on regulatory level, an occurrence frequency that is a frequency of occurrences of a sudden brake operation, a sudden accelerator operation, a sudden steering-wheel operation, and/or a gaze directed to display or display window indicating or displaying an execution of an application. The state acquisition section 20 and the usage evaluation section 30 acquire, as an information data on user layer, a user information data such as an age, a gender, and a level of driving skill.

The sudden brake operation or sudden accelerator operation in a vehicle may be conducted in the case that an inter-vehicle distance of the vehicle to an immediately adjacent vehicle becomes shorter or longer due to inattentive driving or failure to look at the traveling direction along a road. In addition, the sudden steering-wheel operation (or handling) in the vehicle may be conducted in the case that the vehicle becomes closer to an obstacle due to inattentive driving or failure to look at the traveling direction along a road. The occurrence frequency of a sudden brake operation, a sudden accelerator operation, and/or a sudden steering-wheel operation conducted during execution of an application may signify a frequency of needs of a sudden driving operation in the vehicle during the execution of the application. In contrast, the gaze of a user (i.e., driver) directed at the display apparatus 80 (i.e., display or execution display window) that displays execution of an application may signify an inattentive driving or a driving with the eyes looking aside or away. That is, the occurrence frequency of a gaze directed at the display showing execution of an application or the display window during the execution of the application may signify a frequency of occurrences of driving with eyes looking away during the execution of the application. Further, each of (i) the occurrence frequency of a sudden driving operation in the vehicle during execution of an application and the occurrence frequency of a gaze directed at the display window showing the execution of the application may signify a frequency of occurrences of driving destructive to safety or endangering safe driving. The display apparatus 80 includes a liquid crystal display or an organic electroluminescence display, which is provided with a screen that displays a display window or display image.

Thus, when the occurrence frequency of a sudden driving operation of the vehicle during execution of an application or the occurrence frequency of a gaze directed at the display window showing the execution of the application is significantly high, i.e., when the above occurrence frequency of driving destructive to safety is significantly high, the information center 70 managing the attributes of the application needs to change the regulatory level so as to strengthen the regulation of executing the application. By contrast, when the occurrence frequency of a sudden driving operation of the vehicle during execution of the application or the occurrence frequency of a gaze directed at the display window showing the execution of the application is significantly low, the information center 70 may change the regulatory level so as to lighten the regulation of executing the application. To that end, the state acquisition section 20 and the usage evaluation section 30 acquire, as an information data on regulatory level, an occurrence frequency of a sudden brake operation, a sudden accelerator operation, a sudden steering-wheel operation, and/or a gaze directed at display or an execution display window demonstrating the execution of the application.

The state acquisition section 20 includes an application state acquisition section 21, a vehicle state acquisition section 22, and a driver state acquisition section 23. The application state acquisition section 21 acquires an application state of a subject application being under activation among a plurality of applications enabled to be executed in the in-vehicle apparatus 10, thereby transmitting the application state of the subject application to the usage evaluation section 30; the application state includes an identification of the subject application under activation, an execution phase of the subject application, and an operating state for the subject application.

The vehicle state acquisition section 22 receives respective detection values from an acceleration sensor 11, a steering angle sensor 13, a brake sensor 14, an accelerator sensor 15 (also referred to as an accelerator pedal sensor 15), and a speed sensor 16. The acceleration sensor 11 detects an acceleration of the vehicle. The steering angle sensor 13 detects a steering angle of the steering wheel of the vehicle. The brake sensor 14 detects an operating angle (amount of stepping-on) of the brake pedal. The accelerator sensor 15 detects an operating angle (amount of stepping-on) of the accelerator pedal. The speed sensor 16 detects a speed of the vehicle.

The driver state acquisition section 23 receives (i) user's sight line information data from a camera 17 which detects a user's sight line direction, and (ii) user's heart rate from a heartbeat sensor 18 which detects a heart rate of a user. In addition, the driver state acquisition section 23 acquires user information data according to inputs by the user, and transmits the acquired user information data to the usage evaluation section 30. It is noted that after a user (i.e., driver) is identified, a previously registered user information data corresponding to the identified user may be transmitted to the usage evaluation section 30.

The vehicle state acquisition section 22 acquires an occurrence of a sudden brake operation (i.e., sudden deceleration) or a sudden accelerator operation (i.e., sudden acceleration) based on detection values received from the acceleration sensor 11. In addition, the vehicle state acquisition section 22 acquires an occurrence of a sudden brake operation based on a detection value and a detection duration received from the brake sensor 14. The vehicle state acquisition section 22 may differently acquire an occurrence of a sudden brake operation based on (i) a detection value received from the acceleration sensor 11 or the brake sensor 14 and (ii) a heart rate received by the driver state acquisition section 23 from the heartbeat sensor 18. In addition, the vehicle state acquisition section 22 acquires an occurrence of a sudden accelerator operation based on (i) a detection value from the speed sensor 16 and (ii) a detection value received from the accelerator sensor 15. In addition, the vehicle state acquisition section 22 acquires an occurrence of a sudden steering-wheel operation (i.e., a sudden change of traveling direction) based on (i) a detection value from the speed sensor 16 and (ii) a detection value from the steering angle sensor 13. Furthermore, the vehicle state acquisition section 22 acquires an occurrence of a gaze directed at display or display window based on the sight line information data of the driver received by the driver state acquisition section 23 from the camera 17. Thereby, each time the sudden deceleration, the sudden acceleration, the sudden change of traveling direction, or the gaze directed at display occurs, the vehicle state acquisition section 22 notifies the usage evaluation section 30 of the occurrence.

The usage evaluation section 30 includes a calculation section 31 and a statistics section 33. The calculation section 31 calculates an occurrence count that is a count (or the number) of occurrences of each of a sudden deceleration, a sudden acceleration, a sudden change of traveling direction, and a gaze directed at display, all of which are acquired or detected during execution of the application, based on (i) an application state transmitted from the application state acquisition section 21, and (ii) an occurrence of each of a sudden deceleration, a sudden acceleration, a sudden change of traveling direction, and a gaze directed at display, all of which are transmitted from the vehicle state acquisition section 22.

The calculation section 31 stores the respective occurrence counts to be associated with applications which are under activation, thereby managing the respective occurrence counts for every application. In addition, at the end of driving, the calculation section 31 calculates a total activation period of time of an application during the driving, and manages the total activation period of time for every application. Suppose that during driving, a subject application is activated, ended, and then re-activated. In such a case, the calculation section 31 calculates the sum of activation periods of time as a total activation period of time. The calculation section 31 also manages, for every application, a total occurrence count of each of a sudden deceleration, a sudden acceleration, a sudden change of traveling direction, and a gaze directed at display during driving. It is noted that, an occurrence count of an operation conducted by a user signifies (i) the number of times the operation by the user occurs or is detected, or (ii) the number of times the user conducts the operation. Further, the occurrence count signifies a numerical value representing how many operations the user conducts.

Further, the calculation section 31 calculates an occurrence frequency of each of a sudden deceleration, a sudden acceleration, a sudden change of traveling direction, and a gaze directed at display during driving. To be specific, an occurrence frequency is obtained by dividing a total occurrence count by a total activation period of time; the total occurrence count is of each of a sudden deceleration, a sudden acceleration, a sudden change of traveling direction, and a gaze directed at the display. The calculation section 31 transmits the respective calculated occurrence frequencies to the attribute management section 40. The processes of calculating the respective occurrence frequencies will be explained later.

The statistics section 33 keeps statistics of the user information data which are transmitted from the driver state acquisition section 23 for every application, preparing a correspondence table of the user information data and the applications. The statistics section 33 transmits the statistics (including the correspondence table) of user information data to the attribute management section 40. It is noted that in the present embodiment, the application state acquisition section 21, the vehicle state acquisition section 22, and the driver state acquisition section 23 function as an occurrence acquisition section; the application state acquisition section 21, the vehicle state acquisition section 22, the driver state acquisition section 23, and the calculation section 31 function as a frequency acquisition section; and the driver state acquisition section 23 and the statistics section 33 function as a user information acquisition section.

The attribute management section 40 manages the attributes designated for every application. The attribute management section 40 receives general-attribute information data from the information center 70 periodically via the center communication section 60, and updates the attributes designated for the applications based on the received general-attribute information data. In addition, the attribute management section 40 transmits the user information data or the occurrence frequencies, which are accumulated up to a predetermined amount, via the center communication section 60 to the information center 70 each time an application is executed for a predetermined period of time or by a predetermined count (predetermined times). It is noted that the predetermined period of time or predetermined count is differentiated between the applications or between the transmitted information data. The attribute management section 40 and the center communication section 60 function as an information data transmission section in the present embodiment.

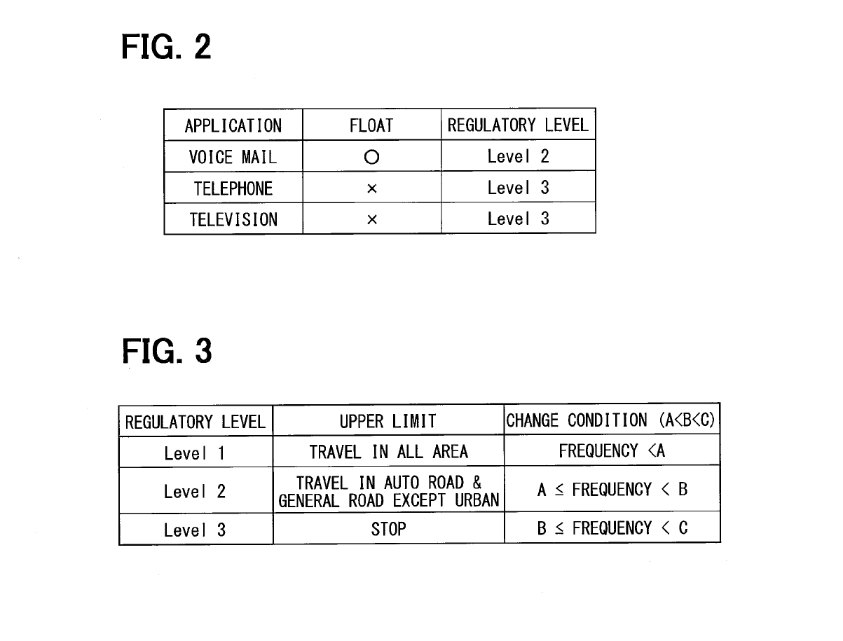

The application management section 50 acquires information data on road under travel of the vehicle from map data etc., and conducts execution or interruption (stop) of an application according to the acquired information data on road and the regulatory level designated for the application. FIG. 2 illustrates an example of correspondence between the types of applications and the regulatory level. FIG. 3 illustrates an example of correspondence between a regulatory level and an upper limit of permitted range of driving workload that permits execution of an application. FIG. 2 also indicates a float attribute, “O” of which represents that change of a regulatory level is enabled, and “X” of which represents that change of a regulatory level is disabled.

An application of telephone or television is assigned with the level 3 of regulatory level that indicates execution of the application is permitted only with the upper limit of driving workload being a vehicle stop state, i.e., with the driving workload being smallest; this assignment cannot be changed. An application of voice mail is assigned, at an initial setup, with the level 2 of regulatory level that indicates execution of the application is permitted with the upper limit of driving workload being a limited vehicle travel state where the vehicle travels (i) an automobile road where only automobiles are permitted to travel or (ii) a general road excluding roads in urban areas. That is, the application of voice mail can be executed when the vehicle stops or when the vehicle travels an automobile road; in contrast, the application of voice mail cannot be executed when the vehicle travels a general road in an urban area. The general regulatory level designated for the application of voice mail can be changed by the information center 70.

The center communication section 60 communicates with the information center 70 using a wireless communication system such as Wi-Fi (registered trademark). The center communication section 60 acquires the respective occurrence frequencies or user information data from the state acquisition section 20 and the usage evaluation section 30, and then transmits the acquired ones to the information center 70, while receiving the general-attribute information data of applications from the information center 70.

The information center 70 includes a computer having a CPU, ROM, RAM, storage device, I/O, and a bus line that connects the foregoing, to manage the general attributes of the applications that are executed by a plurality of in-vehicle apparatuses 10 mounted in a plurality of different vehicles. The information center 70 receives the general-attribute information data on general attributes from the plurality of in-vehicle apparatuses 10; the general attributes include the user information data and the occurrence frequencies that include the occurrence frequency of the sudden deceleration, the occurrence frequency of the sudden acceleration, the occurrence frequency of the sudden change of traveling direction, and the occurrence frequency of the gaze directed at display. The information center 70 feeds back the received information data so as to update the general attributes of the applications. That is, the information center 70 updates the general attributes based on the practical usages of the applications received from the plurality of the in-vehicle apparatuses 10.

For example, suppose a case where a tendency of a high frequency is exhibited with respect to a subject application by any one of the occurrence frequency of the sudden deceleration, the occurrence frequency of the sudden acceleration, the occurrence frequency of the sudden change of traveling direction, or the occurrence frequency of gaze directed at display, which is received from each of the plurality of in-vehicle apparatuses 10. In such a case, the regulatory level of the subject application is increased to strengthen the regulation. In contrast, in the case where a tendency of a low frequency is exhibited, the regulatory level of the subject application is decreased to lighten the regulation. Without need of limiting the number of the occurrence frequencies exhibiting a tendency of a high frequency to a single occurrence frequency, for instance, if the predetermined number of the occurrence frequencies each exhibit a tendency of a high frequency, the regulatory level of the subject application may be increased; in contrast, the predetermined number of the occurrence frequencies each exhibit a tendency of a low frequency, the regulatory level of the subject application may be decreased. For instance, if the occurrence frequency of the sudden deceleration and the occurrence frequency of the sudden acceleration each exhibit a tendency of a high frequency, the regulatory level of the subject application may be increased; in contrast, the occurrence frequency of the sudden deceleration and the occurrence frequency of the sudden acceleration each exhibit a tendency of a low frequency, the regulatory level of the subject application may be decreased.

In addition, suppose a case where the user information data received from the plurality of in-vehicle apparatuses 10 indicate a tendency of change from an initial setup. In such a case, the received user information data are reflected to update the user layer. For example, a subject application is initially assigned with a user layer of male, whereas actual users of the subject application are found to include females more than males. In such a case, the male designated as the user layer of the subject application is updated to the female.

In addition, the information center 70 transmits periodically the general-attribute information data, which are updated based on the practical usages of a plurality of users, to the plurality of in-vehicle apparatuses 10. Therefore, each in-vehicle apparatus 10 can acquire periodically the general-attribute information data on which the practical usages in the plurality of in-vehicle apparatuses 10 are fed back,

The following will explain processes by the vehicle state acquisition section 22 and calculation section 31 to calculate an occurrence frequency of each of a sudden deceleration, a sudden acceleration, a sudden change of traveling direction, or a gaze directed at display indicating execution or activation of an application.

First, a process of calculating an occurrence frequency of a sudden deceleration and a sudden acceleration will be explained which is executed by the vehicle state acquisition section 22 and the calculation section 31, with reference to

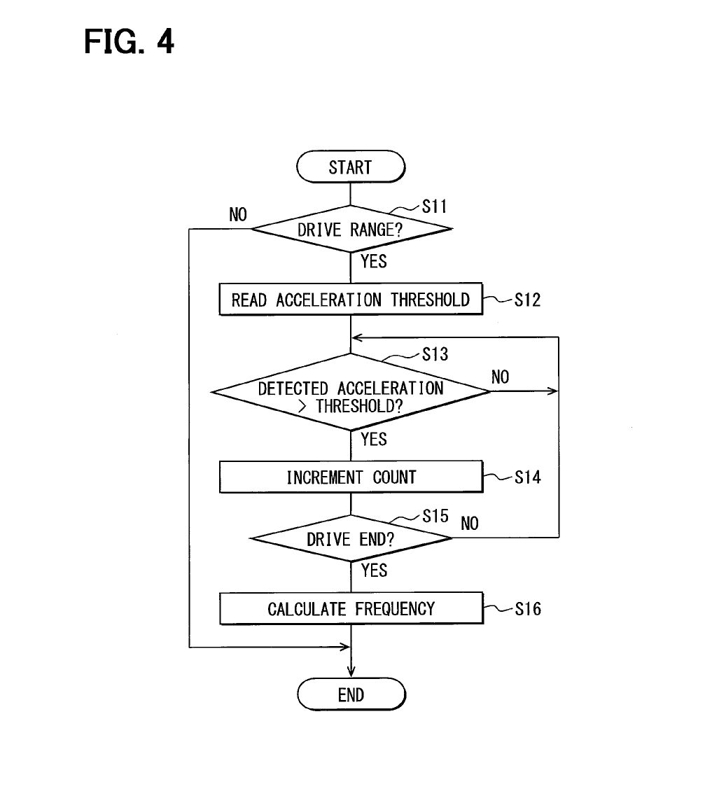

FIG. 4. The processing at S11 to S13 is executed by the vehicle state acquisition section 22, while the processing at S14 to S16 is executed by the calculation section 31.

At S11, it is determined whether the shift position of the vehicle is the drive range, based on a detection value of a shift position sensor (unshown). That is, it is determined whether a driving is started or not. When the shift position is not the drive range (S11: NO), the present process ends. When the shift position is the drive range (S11: YES), the processing proceeds to S12.

At S12, a threshold value of the acceleration is read out which is used for determining whether a sudden deceleration or a sudden acceleration occurs. Sudden deceleration or sudden acceleration of the vehicle naturally subjects the vehicle to an acceleration greater than that in a usual traveling state; thus, the threshold value is assigned with a value greater than an acceleration applied to the vehicle in a usual traveling state.

At S13, it is determined whether the detection value of the acceleration sensor 11 is greater than the threshold value read at S12. When the detection value of the acceleration sensor 11 is equal to or less than the threshold value (S13: NO), the determination at S13 is repeatedly performed. When the detection value of the acceleration sensor 11 is greater than the threshold value (S13: YES), it is determined that a sudden deceleration or a sudden acceleration occurred, thereby reporting an occurrence of the sudden deceleration or sudden acceleration from the vehicle state acquisition section 22 to the calculation section 31,

At S14, an occurrence count of the sudden deceleration or sudden acceleration is incremented in response to the report of occurrence of the sudden deceleration or sudden acceleration.

At S15, it is determined whether the driving of the vehicle ends or is interrupted. In detail, it is determined whether the shift position is the parking range. When the shift position is not the parking range, it is determined that the driving of the vehicle is continued (S15: NO), the processing returns to S13. In contrast, when the shift position is the parking range, it is determined that the driving of the vehicle ends (S15: YES), the processing proceeds to S16.

At S16, the occurrence frequency is calculated by dividing the total occurrence count of the sudden deceleration or sudden acceleration during the driving by the total activation period of time of each of the applications during the driving. Then, the present process ends.

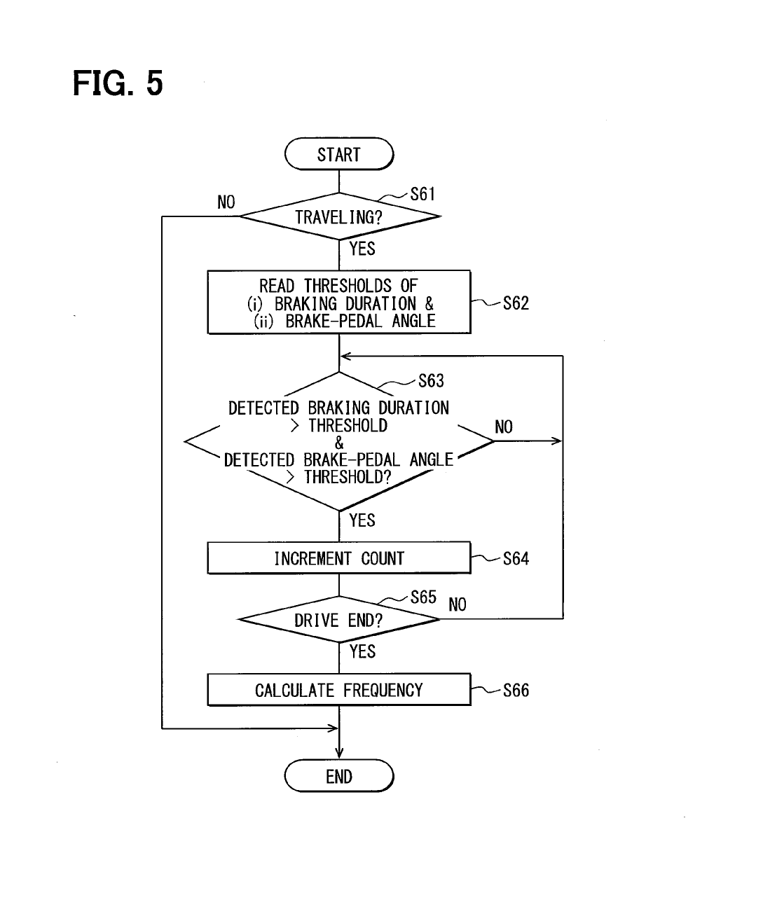

Next, a process of calculating an occurrence frequency of a sudden deceleration is explained which is executed by the vehicle state acquisition section 22 and the calculation section 31, with reference to FIG. 5. The processing at S61 to S63 is executed by the vehicle state acquisition section 22, while the processing at S64 to S66 is executed by the calculation section 31.

At S61, it is determined whether the vehicle is during traveling. To be specific, when the shift position is not the drive range, it is determined that it is not during traveling. When the shift position is the drive range, it is determined that it is during traveling. When it is not during traveling (S61: NO), the present process ends. When it is during traveling (S61: YES), the processing proceeds to S62.

At S62, two threshold values are read out which are used for determining whether a sudden deceleration occurs; one threshold value is of braking duration and the other threshold value is of operating angle of the brake pedal. The threshold value of braking duration is designated to be a value that excludes pumping braking that the driver performs intentionally.

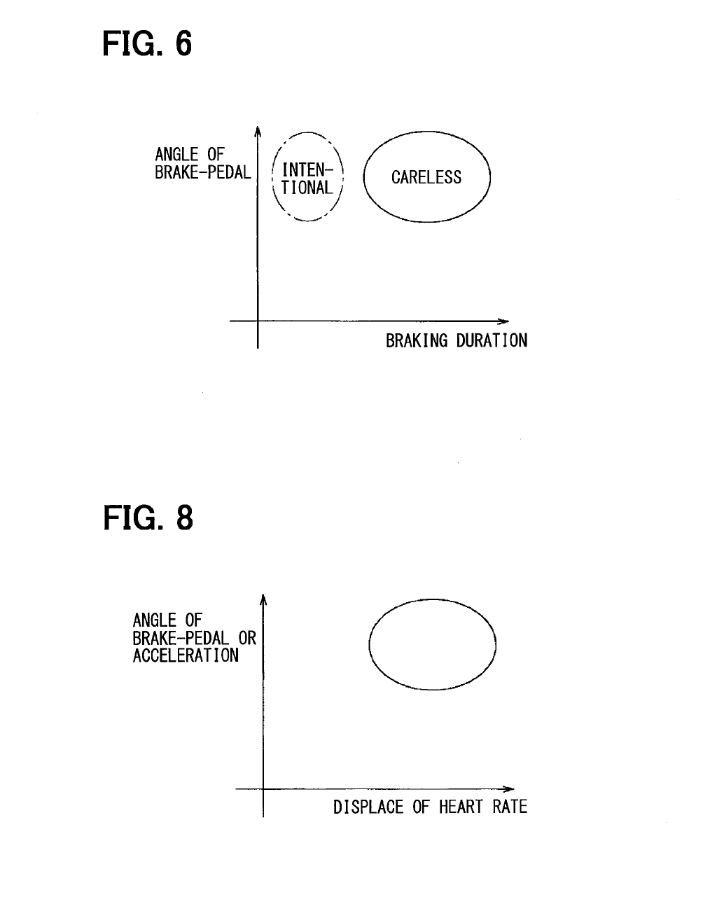

At S63, it is determined whether a sudden deceleration occurred based on a detection value of the brake sensor 14. To be specific, when (i) the detected braking duration is longer than the threshold value of braking duration read at S62, and, simultaneously, (ii) the detected operating angle of brake pedal is greater than the threshold value of operating angle read at S62, it is determined that a sudden deceleration occurred. Otherwise, it is determined that no sudden deceleration occurred. With reference to FIG. 6, only when the driver conducts a sudden brake operation resulting from user's carelessness, it is determined that a sudden deceleration occurred. When the driver conducts pumping braking intentionally, it is not determined that a sudden deceleration occurred. When it is determined that any sudden deceleration did not occur (S63: NO), the determination at S63 is repeatedly performed. When it is determined that a sudden deceleration occurred (S63: YES), an occurrence of the sudden deceleration is reported from the vehicle state acquisition section 22 to the calculation section 31. Then, the processing proceeds to S64.

At S64, an occurrence count of the sudden deceleration is incremented in response to the report of the occurrence of the sudden deceleration.

At S65, it is determined whether the driving of the vehicle ends or not, like S15. When the driving does not end (S65: NO), the processing returns to S63. In contrast, when the driving ends (S65: YES), the processing proceeds to S66.

At S66, the occurrence frequency is calculated by dividing the total occurrence count of the sudden deceleration during the driving by the total activation period of time of each of the applications during the driving. Then, the present process ends.

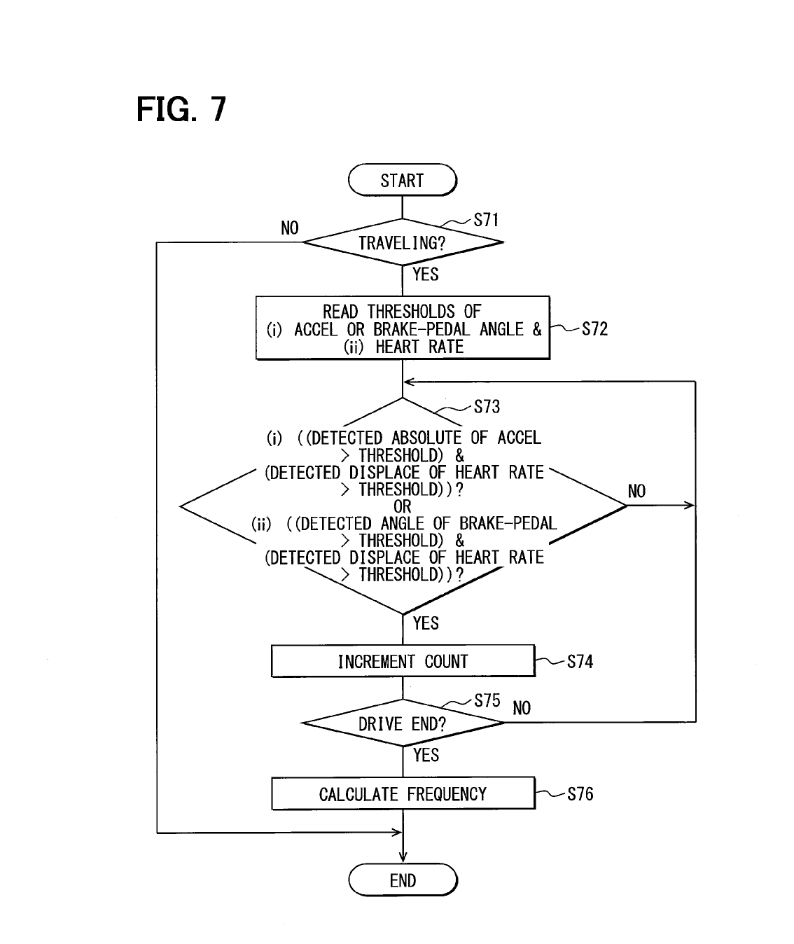

Alternatively, the occurrence count of a sudden deceleration may be calculated by the vehicle state acquisition section 22 and the calculation section 31 using a flowchart of FIG. 7. The processing at S71 to S73 is executed by the vehicle state acquisition section 22 and driver state acquisition section 23, while the processing at S74 to S76 is executed by the calculation section 31.

At S71, like at S61, it is determined whether the vehicle is during traveling. When it is not during traveling (S71: NO), the present process ends. When it is during traveling (S71: YES), the processing proceeds to S72.

At S72, threshold values are read out which are used for determining whether a sudden deceleration occurs; one threshold value is of either acceleration or operating angle (amount of stepping-on) of the brake pedal, whereas the other threshold value is of heart rate displacement of the driver. An acceleration at deceleration is applied to the vehicle backward; thus, the absolute value of the detection value of the acceleration sensor 11 indicates a decreasing rate of speed. The threshold value of acceleration is designated to be a positive value. In addition, when the driver steps on the brake or brake pedal resulting from driver's carelessness, the heart rate of the driver rises. In contrast, when the driver conducts pumping braking intentionally, the heart rate does not rise. Thus, the threshold value of heart rate displacement is designated to be a value which enables determination of the heart rate having risen.

At S73, it is determined whether a sudden deceleration occurred based on (i) a detection value of the acceleration sensor 11 or brake sensor 14, and (ii) a detection value of the heartbeat sensor 18. To be specific, when the operating angle (amount of stepping-on) of the brake pedal detected by the brake sensor 14 is greater than the threshold value (first threshold value) of operating angle read at S72, and, simultaneously, the rising amount of heart rate is greater than the threshold value (second threshold value) of heart rate displacement read at S72, it is determined that a sudden deceleration occurred. Alternatively, when the absolute value of the acceleration detected by the acceleration sensor 11 is greater than the threshold value (third threshold value) of acceleration read at S72, and, simultaneously, the rising amount of the heart rate is greater than the threshold value (fourth threshold value) of heart rate displacement read at S72, it is determined that a sudden deceleration occurred. Otherwise, it is determined that no sudden deceleration occurred. With reference to FIG. 8, only when the driver conducts a sudden brake operation due to carelessness, it is determined that a sudden deceleration occurred. When the driver conducts pumping braking intentionally, it is not determined that a sudden deceleration occurred. When it is determined that any sudden deceleration did not occur (S73: NO), the determination at S73 is repeatedly performed. When it is determined that a sudden deceleration occurred (S73: YES), an occurrence of the sudden deceleration is reported from the vehicle state acquisition section 22 to the calculation section 31. Then, the processing proceeds to S74.

At S74, an occurrence count of sudden deceleration is incremented in response to the report of the occurrence of the sudden deceleration.

At S75, it is determined whether the driving of the vehicle ends or not, like S65. When the driving does not end (S75: NO), the processing returns to S73. In contrast, when the driving ends (S75: YES), the processing proceeds to S76.

At S76, the occurrence frequency is calculated by dividing the total occurrence count of the sudden deceleration during the driving by the total activation period of time of each of the applications during the driving. Then, the present process ends.

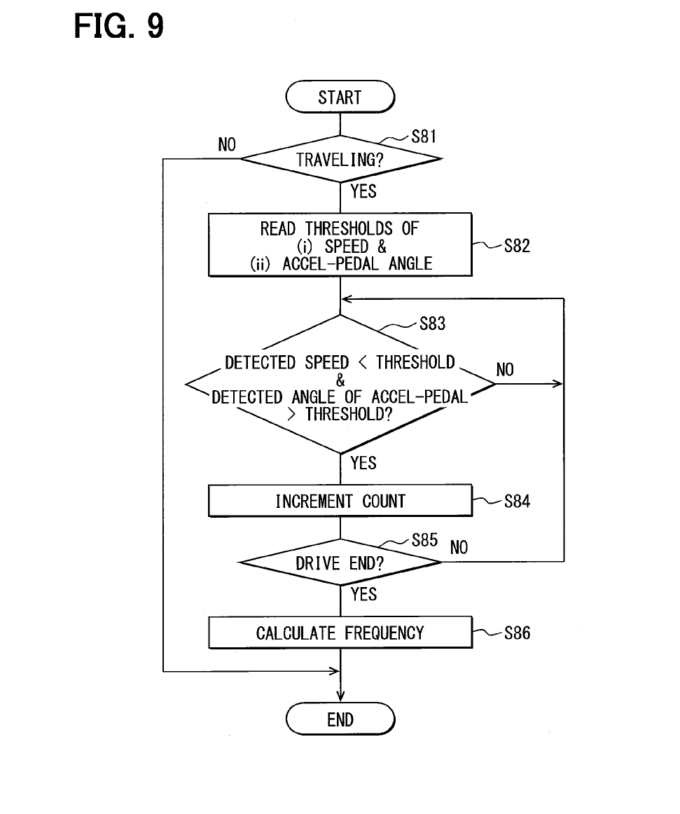

Next, a process of calculating an occurrence frequency of a sudden acceleration is explained which is executed by the vehicle state acquisition section 22 and the calculation section 31, with reference to FIG. 9. The processing at S81 to S83 is executed by the vehicle state acquisition section 22, while the processing at S84 to S86 is executed by the calculation section 31.

At S81, like at S61, it is determined whether the vehicle is during traveling. When it is not during traveling (S81: NO), the present process ends. When it is during traveling (S81: YES), the processing proceeds to S82.

At S82, two threshold values are read out which are used for determining whether a sudden acceleration occurs; one threshold value is of vehicle speed and the other threshold value is of operation angle of the accelerator pedal. A sudden accelerator operation that endangers safety is conducted, for instance, in following cases. A first case may occur where the driver focuses on an application being activated or executing during very slow traveling due to traffic congestion or traffic signal so that an inter-vehicle distance of the vehicle with a followee vehicle (a vehicle ahead of the vehicle) becomes longer. A second case may occur where the driver hurries up to a destination. Thereby, the threshold value of vehicle speed is designated to be a value which enables the determination of very slow traveling due to traffic congestion or traffic signal.

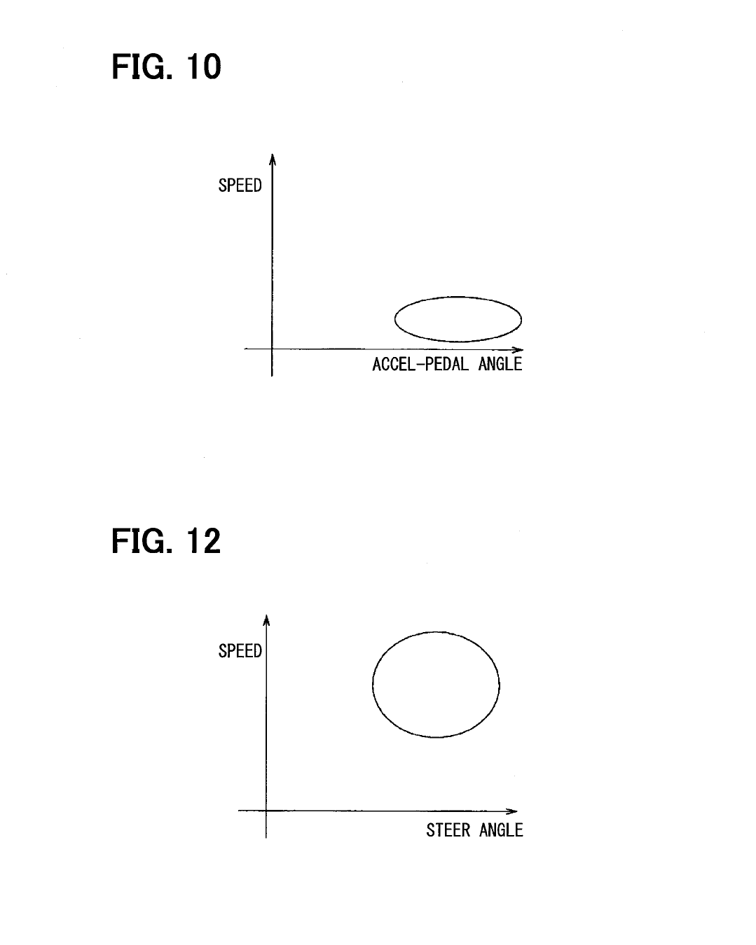

At S83, it is determined whether a sudden acceleration occurred based on (i) a detection value of the vehicle speed sensor 16, and (ii) a detection value of the accelerator sensor 15. To be specific, when (i) the detected vehicle speed is smaller than the threshold value of vehicle speed read at S82, and, simultaneously, (ii) the detected operating angle of accelerator pedal is greater than the threshold value of operating angle read at S82, it is determined that a sudden acceleration occurred. Otherwise, it is determined that no sudden acceleration occurred. With reference to FIG. 10, only when the driver conducts a sudden accelerator operation from very slowly traveling state, it is determined that a sudden acceleration occurred. When it is determined that any sudden acceleration did not occur (S83: NO), the determination at S83 is repeatedly performed. When it is determined that a sudden acceleration occurred (S83: YES), an occurrence of the sudden acceleration is reported from the vehicle state acquisition section 22 to the calculation section 31. Then, the processing proceeds to S84.

At S84, an occurrence count of the sudden acceleration is incremented in response to the report of the occurrence of the sudden acceleration.

At S85, it is determined whether the driving of the vehicle ends or not, like S65. When the driving does not end (S85: NO), the processing returns to S83. In contrast, when the driving ends (S85: YES), the processing proceeds to S86.

At S86, the occurrence frequency is calculated by dividing the total occurrence count of the sudden acceleration during the driving by the total activation period of time of each of the applications during the driving. Then, the present process ends.

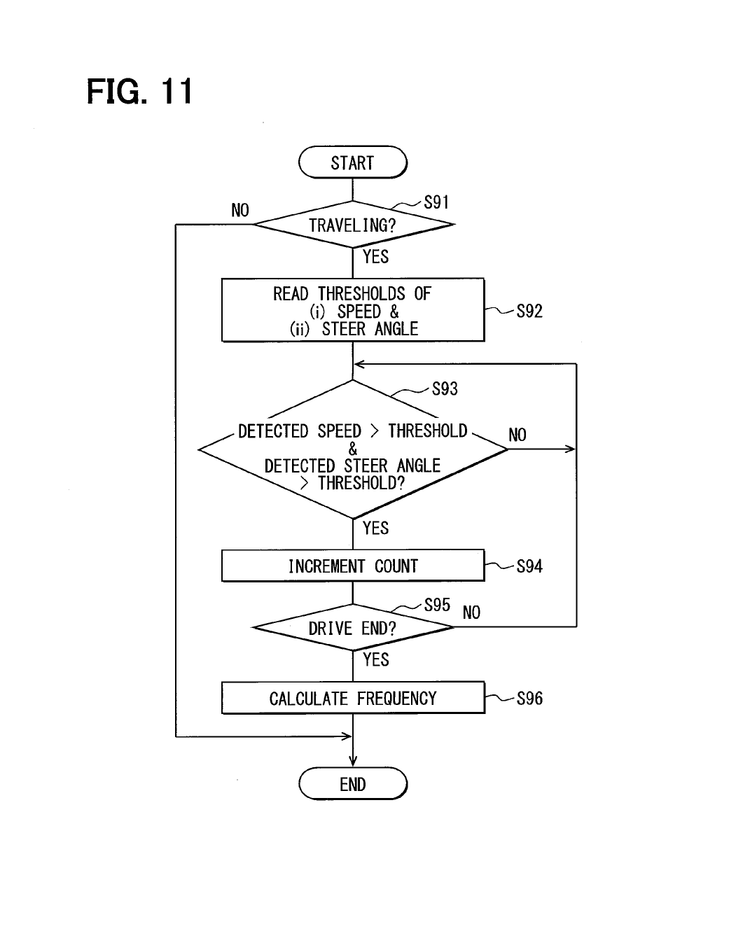

Next, a process of calculating an occurrence frequency of a sudden change of traveling direction is explained which is executed by the vehicle state acquisition section 22 and the calculation section 31, with reference to FIG. 11. The processing at S91 to S93 is executed by the vehicle state acquisition section 22, while the processing at S94 to S96 is executed by the calculation section 31.

At S91, like at S61, it is determined whether the vehicle is during traveling. When it is not during traveling (S91: NO), the present process ends. When it is during traveling (S91: YES), the processing proceeds to S92.

At S92, two threshold values for determining whether a sudden change of traveling direction occurs are read out; one threshold value is of vehicle speed and the other threshold value of steering angle. When the driver parks the vehicle or starting the vehicle from parking state, a steering angle of steering wheel becomes great in very slow traveling state. Thus, the threshold value of vehicle speed is designated to be a value that can exclude the condition of parking the vehicle and the condition of starting the vehicle from parking state.

At S93, it is determined whether a sudden change of traveling direction occurred based on (i) a detection value of the vehicle speed sensor 16, and (ii) a detection value of the steering angle sensor 13. To be specific, when (i) the detected vehicle speed is greater than the threshold value of vehicle speed read at S92, and, simultaneously, (ii) the detected steering angle is greater than the threshold value of steering angle read at S92, it is determined that a sudden change of traveling direction occurred. Otherwise, it is determined that no sudden change of traveling direction occurred. With reference to FIG. 12, only in cases that the driver suddenly handles the steering wheel while the vehicle runs at a speed faster than the threshold value of vehicle speed, it is determined that a sudden change of traveling direction occurred. When it is determined that any sudden change of traveling direction did not occur (S93: NO), the determination at S93 is repeatedly performed. When it is determined that a sudden change of traveling direction occurred (S93: YES), an occurrence of the sudden change of traveling direction is reported from the vehicle state acquisition section 22 to the calculation section 31. Then, the processing proceeds to S94.

At S94, an occurrence count of the sudden change of traveling direction is incremented in response to the report of the occurrence of the sudden change of traveling direction.

At S95, it is determined whether the driving of the vehicle ends or not, like S15. When the driving does not end (S95: NO), the processing returns to S93.

At S96, the occurrence frequency is calculated by dividing the total occurrence count of the sudden change of traveling direction during the driving by the total activation period of time of each of the applications during the driving. Then, the present process ends.

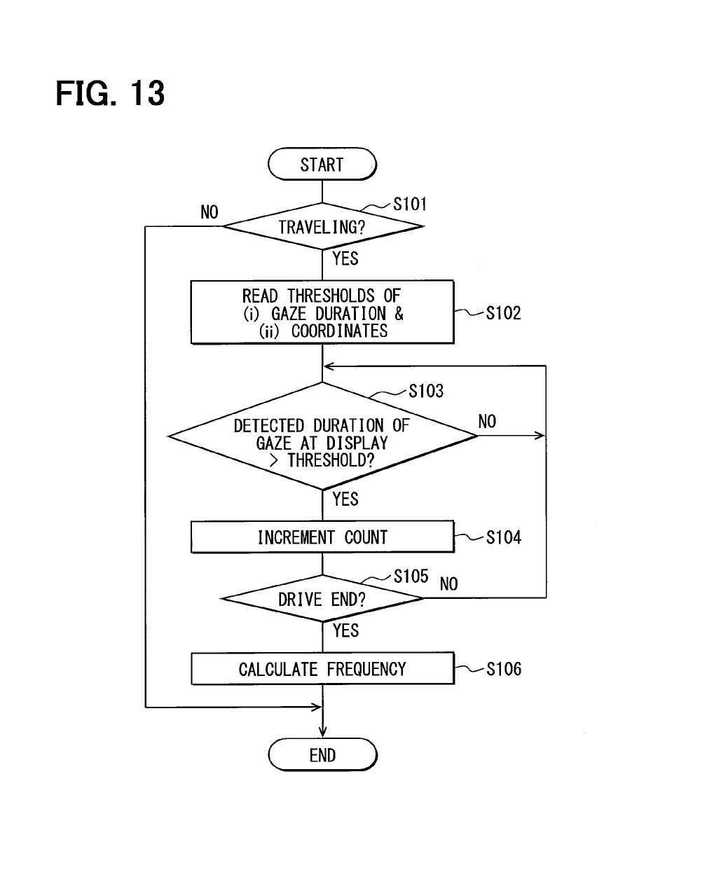

Next, a process of calculating an occurrence frequency of a gaze directed at display is explained which is executed by the vehicle state acquisition section 22 and the calculation section 31, with reference to FIG. 13. The processing at S101 to S103 is executed by the vehicle state acquisition section 22 and driver state acquisition section 23, while the processing at S104 to S106 is executed by the calculation section 31.

At S101, like at S61, it is determined whether the vehicle is during traveling. When it is not during traveling (101: NO), the present process ends. When it is during traveling (S101: YES), the processing proceeds to S102.

At S102, two threshold values for determining whether a gaze directed at display or display window indicating executing an application occurs are read out; one threshold value is of gaze duration and the other threshold value is of coordinates of the display or the display window of the application in the display apparatus 80. The threshold value of gaze duration is designated to be a duration value that may endanger safety in driving.

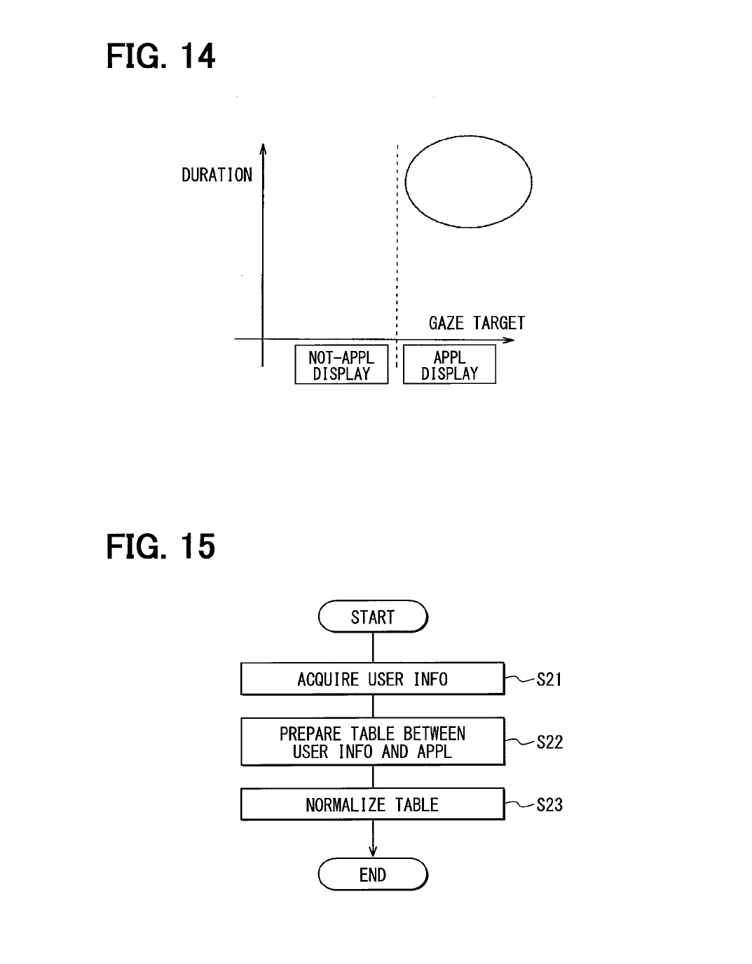

At S103, it is determined whether a gaze directed at display indicating execution of an application occurred based on a gaze position, at which the gaze is directed, and a gaze duration, for which the gaze is continued; the gaze position and gaze duration are detected with a camera 17. To be specific, when the detected gaze position corresponds to the coordinates of the display window indicating execution of the application read at S102, and, simultaneously, the detected gaze duration is longer than the threshold value read at S102, it is determined that a gaze directed at display indicating execution of the application occurred. With reference to FIG. 14, only when the driver continues to see the application display window longer than the threshold value of gaze duration, it is determined that a gaze directed at display indicating execution of the application occurred. When it is determined that no gaze directed at display did not occur (S103: NO), the determination at S103 is repeatedly performed. When it is determined that a gaze directed at display occurred (S103: YES), an occurrence of the gaze directed at display is reported from the vehicle state acquisition section 22 to the calculation section 31. Then, the processing proceeds to S104.

At S104, an occurrence count of the gaze directed at display is incremented in response to the report of the occurrence of the gaze directed at display.

At S105, it is determined whether the driving of the vehicle ends or not, like S15. When the driving does not end (S105: NO), the processing returns to S103.

At S106, the occurrence frequency is calculated by dividing the total occurrence count of the gaze directed at display during the driving by the total activation period of time of each of the applications during the driving. Then, the present process ends.

Next, a process of preparing a correspondence table between a user information data and an application is explained which is executed by the driver state acquisition section 23 and the statistics section 33, with reference to FIG. 15. The processing at S21 is executed by the driver state acquisition section 23, while the processing at S22 to S23 is executed by the statistics section 33.

At S21, a user information data that indentifies a user is acquired from the information inputted by the user; the user information data includes an age, a gender, and/or a level of driving skill. The acquired user information data is transmitted to the statistics section 33 from the driver state acquisition section 23.

At S22, the user information data that are accumulated for a predetermined period of time are used for preparing a correspondence (i.e., correspondence table) that associates the user information data with every application. FIG. 16 illustrates the correspondence between (i) ages and genders of user information data and (ii) applications; FIG. 17 illustrates the correspondence between driving skill levels and applications. Each numeral value in FIGS. 16 and 17 indicates a count of uses of an application (referred to as a use count of an application). For instance, FIG. 16 indicates that a male in his twenties uses an application A twice and a female in her thirties uses the application A three times.

At S23, the correspondences or correspondence tables prepared at S22 are normalized to provide a normalized correspondence table between user information data and applications. To be specific, a use frequency of an application is obtained by dividing the use count of the application by a vehicle-getting-in count; the vehicle-getting-in count signifies the number of times a vehicle is mounted with a user (e.g., the number of times a driver gets in the vehicle). Then, the present process ends.

The first embodiment described above provides advantageous effects as follows.
The information center 70 can acquire an information data on general attributes (i.e., general-attribute information data) of a vehicular application software-program (i.e., an application or application software) based on practical usages of the vehicular application software-program. As a result, the information center 70 can feed back the above information data, which are received from a plurality of in-vehicle apparatuses 10, thereby updating the general attributes of the vehicular application software-program.
In particular, the information center 70 can acquire an occurrence frequency that is a frequency of occurrences of a sudden driving operation needed during execution or activation of a vehicular application software-program, as information data relating to a regulatory level that is one of the general attributes of the vehicular application software-program. To be specific, the information center 70 can acquire an occurrence frequency of a sudden brake operation, a sudden accelerator operation, and/or a sudden steering-wheel operation, as the occurrence frequency of the sudden driving operation. As a result, the information center 70 collects the occurrence frequency of the sudden driving operation needed during executing the vehicular application software-program from a plurality of in-vehicle apparatuses 10; thereby, if there is a tendency for the occurrence frequency to be high, the regulatory level of the application software-program can be increased to strengthen or increase a regulation of execution of the vehicular application software-program, if there is a tendency for the occurrence frequency to be low, the regulatory level can be decreased to lighten or decrease the regulation of execution of the vehicular application software-program.
In particular, the information center 70 can acquire an occurrence frequency that is a frequency of occurrences of a user attention to display of execution of a vehicular application software-program in a vehicle, as information data relating to a regulatory level that is one of the general attributes of the vehicular application software-program. The user attention to display of execution of the application software-program may be a user's gaze directed at display or display window that displays or indicates an execution of the application software-program during driving of the vehicle. As a result, the information center 70 collects the occurrence frequency of the user attention to display of execution of the application software-program from a plurality of in-vehicle apparatuses 10; thereby, if there is a tendency for the occurrence frequency to be high, the regulatory level of the application software-program can be increased to strengthen or increase a regulation of execution of the vehicular application software-program, or if there is a tendency for the occurrence frequency to be low, the regulatory level can be decreased to lighten or decrease the regulation of execution of the vehicular application software-program.
In particular, the information center 70 can acquire a user information data that is an information data that identifies a user that uses a vehicular application software-program, as information data relating to a use layer that is one of the general attributes of the vehicular application software-program. As a result, the information center 70 can update the user layer of the application software-program based on the practically acquired user information data. Furthermore, the information center 70 can collect information data that indicate what kind of users practically use the application software-program from a plurality of in-vehicle apparatuses 10, thereby enabling a development of a future application software-program.

### Second Embodiment

A frequency of needs of a sudden driving operation for each vehicular application software-program (hereinafter, also referred to as an application, or application software) varies depending on driving skills of respective users. There may be a risky user involving a high frequency of occurrences of a risky driving operation possibly endangering safety during driving a vehicle. For such a risky user, a regulatory level of the application may need to be increased to strengthen regulation of execution of the application. In contrast, for a safe user involving a low frequency of the occurrences of the risky driving operation, the regulatory level may be decreased to lighten regulation of execution of the application.

To that end, the in-vehicle apparatus 10 according to a second embodiment of the present disclosure is provided to manage a user-specific regulatory level that is a regulatory level specific to a subject use who is any one of users that use the application, and update the user-specific regulatory level based on the occurrence frequency of a sudden deceleration and a sudden acceleration conducted by the subject user. That is, the in-vehicle apparatus 10 according to the second embodiment transmits an acquired information data on general attribute to the information center 70 while updating the user-specific regulatory level of the application based on the occurrence frequency that is one of the information data on general attributes. The regulatory level received from the information center 70 is used as an initial setup value for a new user.

The following explains, with reference to FIG. 1, some constituent elements different from those of the in-vehicle apparatus 10 according to the first embodiment.

The driver state acquisition section 23 acquiring a user information data also identifies a user (i.e., a subject user) based on an identification information data that is detected by an identification unit 12 indicated with broken lines in FIG. 1. The identification unit 12 may be at least one of three units: an ID reader unit that reads an ID of an electronic key of the vehicle; a communication unit that communicates with a portable terminal held by the user via an infrared ray communication, a Bluetooth (registered trademark) communication, or an NFC (Near Field Communication) communication; and a camera that captures an image of the face of a user. The driver state acquisition section 23 identifies the subject user by recognizing at least one of an ID of an electric key of the vehicle held by the subject user, a portable terminal held by the subject user, or the face of the subject user. It is noted that the driver state acquisition section 23 and the statistics section 33 function as a user information acquisition section while the identification unit 12 and the driver state acquisition section 23 function as an identification section.

The usage evaluation section 30 further includes a determination section 32 indicated with broken lines in FIG. 1. The calculation section 31 of the usage evaluation section 30 calculates a user-specific occurrence frequency of a sudden deceleration and a sudden acceleration for a subject user being any one of users who use a subject application that is any one of vehicular applications used in the vehicle, and transmits the calculated user-specific occurrence frequency specific to the subject user for the subject application to the determination section 32. When the subject application corresponds to an application having a float attribute (“O” in FIG. 2), the determination section 32 determines whether the user-specific occurrence frequency satisfies a change condition that is a condition permitting a change of the user-specific regulatory level from a present level to a different level. When the user-specific occurrence frequency satisfies the change condition, the determination section 32 notifies the attribute management section 40 of an update request of updating the user-specific regulatory level.

As indicated in FIG. 3, the change condition is designated to each level of levels 1 to 3 of a regulatory level. The change conditions are represented by the relation between an occurrence frequency and three determination values A, B, C (A<B<C). For example, in cases that the present level is the level 1, when the actual occurrence frequency is provided to be greater than A and less than B, the change condition is satisfied so as to perform an upward transition from the level 1 into the level 2. In contrast, in cases that the present level is the level 2, when the actual occurrence frequency is provided to be less than A, the change condition is satisfied so as to perform a downward transition from the level 2 into the level 1.

It is noted that a comparison period of time for comparing an actual occurrence frequency with the determination values is designated to be different between a downward transition descending the regulatory level and an upward transition ascending the regulatory level; namely, the comparison period of time for the downward transition is designated to be greater than that for the upward transition. To be specific, when the actual occurrence frequency becomes equal to or greater than a predetermined determination value in a first predetermined period of time, the regulatory level is changed or updated from a first level (e.g., the level 1) into a second level (e.g., the level 2). In contrast, when the actual occurrence frequency becomes less than the predetermined determination value in a second predetermined period of time, the regulatory level is changed or updated from the second level into the first level. The second predetermined period of time is designated to be greater than the first predetermined period of time. The first level is designated to be stricter than the first level in regulation of execution of the application. That is, the change condition lightening the regulation of execution of the application is designated to be stricter than the change condition strengthening the regulation of execution of the application.

The attribute management section 40 manages a regulatory level of an application for every user; namely, the attribute management section 40 manages a user-specific regulatory level of a subject vehicular application being any one of a plurality of vehicular applications, the user-specific regulatory level being specific to a subject user who is any one of users who use the subject vehicular application. Upon receiving an update request of updating a regulatory level from the determination section 32, the attribute management section 40 thereby updates a user-specific regulatory level specific to the user identified by the driver state acquisition section 23. In the present embodiment, the attribute management section 40 functions as a management section, while the attribute management section 40 and the determination section 32 of the usage evaluation section 30 function as a regulatory-level update section.

The application management section 50 conducts execution or interruption of a subject application for every user (i.e., subject user) according to the acquired information on road and the user-specific regulatory level specific to the subject user for the subject application.

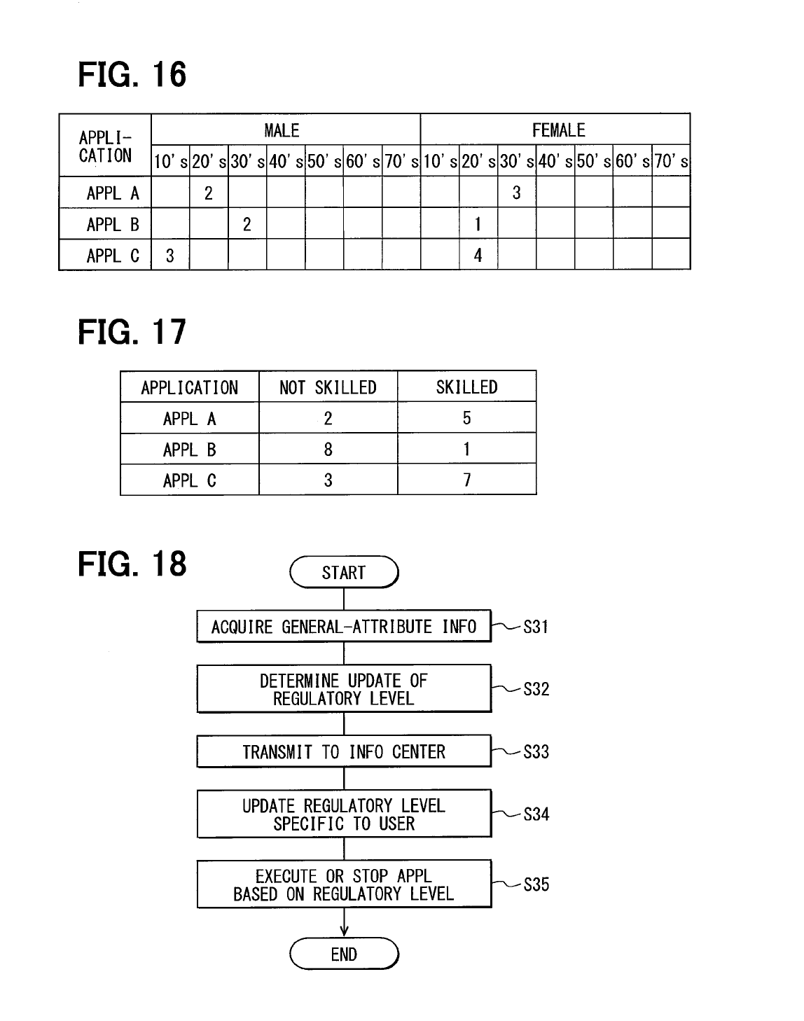

Next, a process for managing applications is explained with reference to FIG. 18. The state acquisition section 20 and the usage evaluation section 30 perform the processing at S31 to S32. The attribute management section 40 performs the processing at S33 and S34. The application management section 50 performs the processing at S35.

At S31, information data about general attributes, such as a user information data and an occurrence frequency of a sudden deceleration and a sudden acceleration, are acquired. At S32, the occurrence frequency of the sudden deceleration and the sudden acceleration is compared with a predetermined determination value; thus, it is determined whether the occurrence frequency satisfies the change condition of the regulatory level. At S33, the information data (i.e., general-attribute information data) on general attributes acquired at S31 are transmitted to the information center 70 when an elapsed period of time for which the application is executed reaches a predetermined period of time. At S34, the regulatory level is updated when the occurrence frequency of the sudden deceleration and the sudden acceleration satisfies the change condition.

At S35, execution or interruption of the application is performed with respect to the identified user according to the road information and the regulatory level.

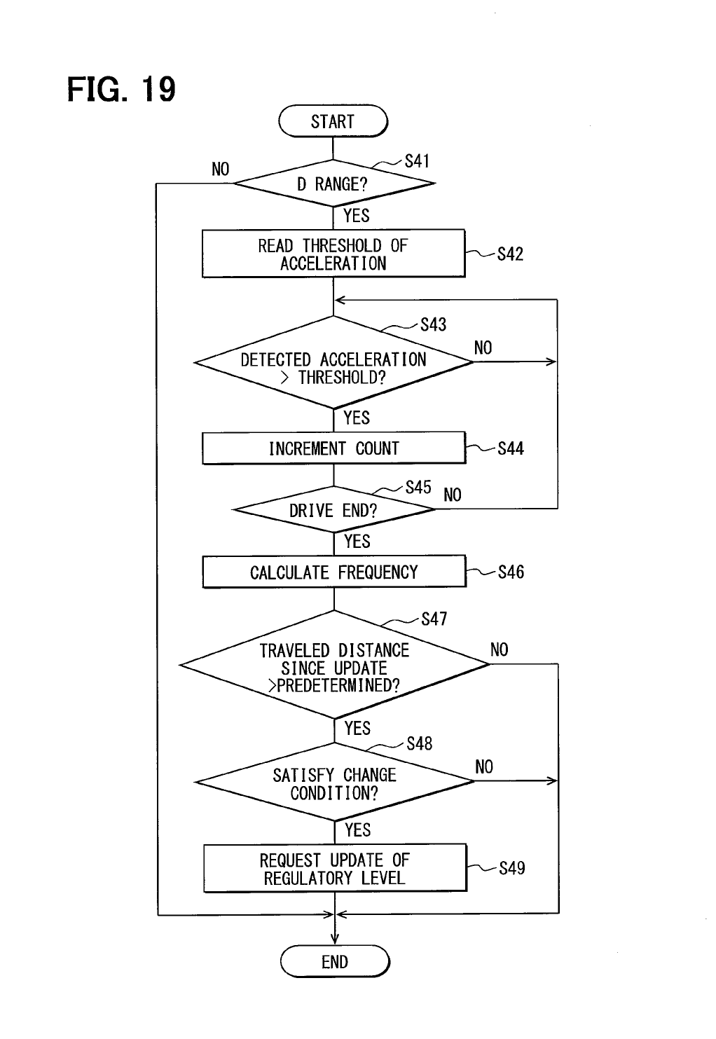

Next, a process for determining whether the occurrence frequency of the sudden deceleration and the sudden acceleration satisfies a change condition of the regulatory level is explained with reference to FIG. 19. The processing at S41 to S43 is executed by the vehicle state acquisition section 22. The processing at S44 to S46 is executed by the calculation section 31. The processing at S47 to S49 is executed by the determination section 32.

The processing at S41 to S46 is comparable with the processing at S14 to S16 in FIG. 4. At S47, it is determined whether the vehicle travels longer than a predetermined distance since the regulatory level was previously updated from the previous level into the present level, preventing the regulatory level from being frequently updated. When the vehicle does not travel longer than the predetermined distance (S47: NO), the present process ends. In contrast, when the driving travels longer than the predetermined distance (S47: YES), the processing proceeds to S48.

At S48, it is determined whether the occurrence frequency calculated at S46 satisfies the change condition of the regulatory level. When the occurrence frequency does not satisfy the change condition (S48: NO), the present process ends. When the occurrence frequency satisfies the change condition (S48: YES), the processing proceeds to S49. At S49, an update request of updating the regulatory level is reported from the determination section 32 to the attribute management section 40. The present process then ends.

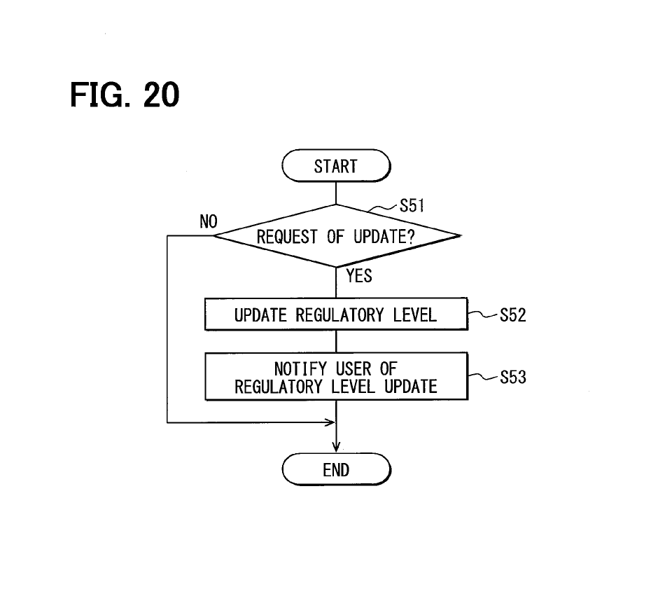

Next, a process for updating a regulatory level by the attribute management section 40 is explained with reference to FIG. 20.

At S51, it is determined whether an update request of updating a regulatory level is received from the determination section 32. When an update request is not received (S51: NO), the present process ends. When an update request is received (S51: YES), the processing proceeds to S52. At S52, the regulatory level is updated according to the update request. The processing proceeds to S53.

At S53, the user is notified of the update of the regulatory level. That is, the user is notified of the regulatory level being strengthened or lightened. Thereby, the user who is notified of the regulatory level being strengthened is urged to conduct safe driving. The present process then ends,

The second embodiment described above provides advantageous effects as follows.
Each in-vehicle apparatus 10 in a subject vehicle can update a user-specific regulatory level assigned to a subject vehicular application software-program based on a driving state of a subject user while the subject application software-program is executed. The subject vehicle is any one of a plurality of vehicles mounted with respective in-vehicle apparatuses 10. The subject user is any one of users who uses the subject application software-program. The subject application software-program is any one of the application software-programs in the vehicle. The user-specific regulatory level is a regulatory level specific to the subject user. This configuration can enhance convenience of the subject user who performs safe driving, resulting in urging users to perform safe driving.
The change condition lightening the regulation for execution of the application software-program is designated to be stricter than the change condition strengthening the regulation for execution of the application software-program. Thus, even if the regulatory level is changed, safe driving is securable. This featured configuration may be set out as follows. The user-specific regulatory level includes a first level and a second level, the second level being stricter than the first level in respect of regulation of execution of the application software-program. The regulatory-level update section updates the user-specific regulatory level from the first level into the second level when the occurrence frequency acquired by the frequency acquisition section becomes equal to or greater than a predetermined determination value in a first predetermined period of time. In contrast, the regulatory-level update section updates the user-specific regulatory level from the second level into the first level when the occurrence frequency acquired by the frequency acquisition section becomes less than the predetermined determination value in a second predetermined period of time that is longer than the first predetermined period of time.
The regulatory-level update section is enabled to update the user-specific regulatory level under a condition that the vehicle travels longer than a predetermined distance since the user-specific regulatory level was updated previously. Thus, the regulatory level is prevented from being updated too frequently. That is, instead of the user's short-term driving state, the user's long-term driving state can be reflected on the regulatory level. Therefore, the user's driving skill can be reflected on the regulatory level more accurately.
The subject user can be identified by recognizing at least one of an ID (identification) of a key of the vehicle held by the subject user, a portable terminal held by the subject user, or the face of the subject user. Even when a plurality of users use a single vehicle, the respective users can be identified certainly.

### Other Embodiments

A comparison period of time for comparing an actual occurrence frequency with the determination values may be designated to be identical between a downward transition descending the regulatory level and an upward transition ascending the regulatory level; namely, the comparison period of time for the downward transition is designated to be identical to that for the upward transition.
The regulatory level may not need to be assigned with three levels alone. For example, two levels may be assigned to the regulatory level such that (i) a first level corresponds to a parking state and a stop state and (ii) a second level corresponds to a traveling state. Alternatively, four levels may be assigned to the regulatory level.
The vehicle state acquisition section 22 may be configured to receive a detection value of the steering angle of the steering wheel from the steering angle sensor 13, and acquire a sudden steering-wheel operation or handling based on the received detection value. To be specific, when a change velocity of the steering angle calculated from the detection value of the steering angle sensor 13 is greater than a threshold value, a sudden steering-wheel operation may be determined.
The application state acquisition section 21, the vehicle state acquisition section 22, and the driver state acquisition section 23 may be configured to acquire an occurrence of at least one of a sudden brake operation, a sudden accelerator operation, a sudden steering-wheel operation, or a gaze directed at display or display window indicating execution of an application software-program.
The application state acquisition section 21, the vehicle state acquisition section 22, the driver state acquisition section 23, and the calculation section 31 may be configured to acquire a frequency of occurrence of at least one of a sudden brake operation, a sudden accelerator operation, a sudden steering-wheel operation, or a gaze directed at display or display window indicating execution of an application software-program.
When receiving a report indicating an occurrence of at least one of a sudden brake operation, a sudden accelerator operation, a sudden steering-wheel operation, or a gaze directed to display or display window indicating execution of an application software-program, the usage evaluation section 30 may notify the attribute management section 40 of the occurrence. Then, the attribute management section 40 can transmit the occurrence of at least one of a sudden brake operation, a sudden accelerator operation, a sudden steering-wheel operation, or a gaze directed to display or display window indicating execution of an application software-program, to the information center 70 via the center communication section 60.
The application state acquisition section 21, the vehicle state acquisition section 22, and the driver state acquisition section 23 may acquire a user's head-turning to display or display window indicating execution of an application software-program, instead of a gaze directed at display or display window indicating execution of an application software-program.
The application state acquisition section 21, the vehicle state acquisition section 22, the driver state acquisition section 23, and the calculation section 31 may acquire a frequency of occurrences of a user's head-turning to display or display window indicating execution of an application software-program, instead of a frequency of occurrences of a gaze directed at display or display window indicating execution of an application software-program.
In the second embodiment, a frequency of occurrences or needs of each of a sudden driving operation may include a frequency of occurrences of a sudden brake operation, a sudden accelerator operation, and sudden steering-wheel operation. That is, the information on regulatory level may be a frequency of occurrences of a sudden deceleration, a sudden acceleration, and a sudden change of traveling direction.
In the second embodiment, the information on regulatory level may be a frequency of occurrences of a user's gaze directed at display indicating execution of an application software-program.
In the second embodiment, a frequency of occurrences of a driving operation possibly endangering safety may be a frequency of occurrence of any one of a sudden brake operation, a sudden accelerator operation, a sudden steering-wheel operation, or a user's gaze directed at display or display window indicating execution of an application software-program.
Further, a frequency of occurrence of a driving operation possibly endangering safety may be a frequency of occurrences of at least two among four operations of (i) a sudden brake operation, (ii) a sudden accelerator operation, (iii) a sudden steering-wheel operation, and (iv) a user's gaze directed at display or display window indicating execution of an application software-program. That is, the information on regulatory level may be a frequency of occurrences of any one or at least two among four operations of (i) a sudden deceleration, (ii) a sudden acceleration, (iii) a sudden change of traveling direction, and (iv) a user's gaze directed at display or display window indicating execution of an application software-program. In such case, at S42 to S46 of the flowchart in FIG. 19, an occurrence frequency may be calculated which is used as the information about the regulatory level.
The center communication section 60 can transmit anonymously the user information data and the frequency of occurrences of a sudden driving operation needed in the vehicle to the information center 70. This can protect the individual information.
When calculating the occurrence count of a sudden deceleration, the sudden deceleration conducted at a sharp curve may be excluded from the sudden decelerations used for calculating the occurrence count.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. An in-vehicle apparatus in a vehicle to execute a vehicular application software-program and communicate with an information center that manages a general attribute of the application software-program,
the in-vehicle apparatus comprising:
an information acquisition section that acquires a general-attribute information data while the application software-program is executed, the general-attribute information data being an information data on the general attribute of the application software-program; and
an information transmission section that transmits the general-attribute information data acquired by the information acquisition section to the information center (i) when a period of time for which the application software-program is executed reaches a predetermined threshold period of time or (ii) when an execution count that is a count of executions of the application software-program reaches a predetermined threshold execution count.

2. The in-vehicle apparatus according to claim 1, wherein
the general attribute includes a regulatory level that indicates a workload range of a driving of the vehicle, the workload range which permits execution of the application software-program during the driving; and
the information acquisition section includes a frequency acquisition section to acquire an occurrence frequency that is a frequency of occurrences of a sudden driving operation performed while the application software-program is executed, the sudden driving operation including at least one of a sudden brake operation, a sudden accelerator operation, or a sudden steering-wheel operation.

3. The in-vehicle apparatus according to claim 1, wherein
the general attribute includes a regulatory level that indicates a workload range of a driving of the vehicle, the workload range which permits execution of the application software-program during the driving; and
the information acquisition section includes an occurrence acquisition section to acquire an occurrence of a sudden driving operation performed while the application software-program is executed, the sudden driving operation including at least one of a sudden brake operation, a sudden accelerator operation, or a sudden steering-wheel operation.

4. The in-vehicle apparatus according to claim 1, wherein
the general attribute includes a regulatory level that indicates a workload range of a driving of the vehicle, the workload range which permits execution of the application software-program during the driving; and
the information acquisition section includes a frequency acquisition section to acquire an occurrence frequency that is a frequency of occurrences of a user attention to display of execution of the application software-program performed while the application software-program is executed, the user attention including at least one of (i) user's gaze directed at display of execution of the application software-program or (ii) user's head-turning to display of execution of the application software-program.

5. The in-vehicle apparatus according to claim 1, wherein:
the general attribute includes a regulatory level that indicates a workload range of a driving of the vehicle, the workload range which permits execution of the application software-program during the driving; and
the information acquisition section includes an occurrence acquisition section to acquire an occurrence of a user attention to display of execution of the application software-program performed while the application software-program is executed, the user attention including at least one of (i) user's gaze directed at display of execution of the application software-program or (ii) user's head-turning to display of execution of the application software-program.

6. The in-vehicle apparatus according to claim 2, further comprising:
a management section that manages a user-specific regulatory level that is the regulatory level specific to a subject user who is any one of users that use the application software-program;
an identification section which identifies the subject user; and
a regulatory-level update section that updates the user-specific regulatory level specific to the subject user identified by the identification section when the occurrence frequency acquired by the frequency acquisition section satisfies an update condition.

7. The in-vehicle apparatus according to claim 6, wherein
the user-specific regulatory level includes a first level and a second level, the second level being stricter than the first level in respect of regulation of execution of the application software-program; and
the regulatory-level update section updates the user-specific regulatory level from the first level into the second level when the occurrence frequency acquired by the frequency acquisition section becomes equal to or greater than a predetermined determination value in a first predetermined period of time, whereas
the regulatory-level update section updates the user-specific regulatory level from the second level into the first level when the occurrence frequency acquired by the frequency acquisition section becomes less than the predetermined determination value in a second predetermined period of time that is longer than the first predetermined period of time.

8. The in-vehicle apparatus according to claim 6, wherein:
the regulatory-level update section is enabled to update the user-specific regulatory level under a condition that the vehicle travels longer than a predetermined distance since the user-specific regulatory level was updated previously.

9. The in-vehicle apparatus according to claim 6, wherein:
the identification section identifies the subject user by recognizing at least one of (i) an identification of a key of the vehicle held by the subject user, (ii) a portable terminal held by the subject user, or (iii) a face of the subject user.

10. The in-vehicle apparatus according to claim 2, wherein:
the frequency acquisition section acquires the occurrence frequency that is the frequency of occurrences of the sudden brake operation performed while the application software-program is executed;
the occurrence of the sudden brake operation is detected
(i) when an amount of stepping onto a brake of the vehicle is greater than a first threshold value and, simultaneously, a displacement of a heart rate of the subject user is greater than a second threshold value, or
(ii) when a decreasing rate of a speed of the vehicle is greater than a third threshold value and, simultaneously, a displacement of the heart rate of the subject user is greater than a fourth threshold value.

11. The in-vehicle apparatus according to claim 1, wherein:
the general attribute includes a user layer of the application software-program; and
the information acquisition section includes a user information acquisition section that acquires a user information data to specify a user that uses the application software-program.

12. The in-vehicle apparatus according to claim 11, wherein:
the user information data includes at least one of an age, a gender, or a driving skill level.

13. The in-vehicle apparatus according to claim 1, wherein:
the information transmission section transmits anonymously the general-attribute information data acquired by the information acquisition section to the information center.
